(19) United States
(12) Patent Application Publication
(10) Pub. No.: US 2026/0187772 A1
(43) Pub. Date: Jul. 2, 2026

(54) AUTOMATED IMAGE QUALITY ASSESSMENT

(71) Applicant: MEDIATEK INC., Hsinchu City (TW)

(72) Inventors: Hsiao-Chien Yang, Hsinchu City (TW); Hsiao-Chieh Wen, Hsinchu City (TW); Tsung-Han Chan, Hsinchu City (TW); Po-Hsun Wang, Hsinchu City (TW); Cheng-Tsai Ho, Hsinchu City (TW); Shih-Heng Chiu, Hsinchu City (TW); An-Tze Lee, Hsinchu City (TW); Tsung-Fei Tsou, Hsinchu City (TW)

(73) Assignee: MEDIATEK INC., Hsinchu City (TW)

(21) Appl. No.: 19/008,610

(22) Filed: Jan. 2, 2025

(51) Int. Cl. G06T 7/00; G06V 10/25; G06V 10/82

(52) U.S. Cl. CPC G06T 7/0002; G06V 10/25; G06V 10/82

(57) ABSTRACT

A method of automated image quality (IQ) assessment using a deep neural network includes detecting a region of interest (ROI) of an image pair to generate a low-quality ROI image and a high-quality ROI image accordingly. The image pair includes a low-quality image and a high-quality image. The method further includes generating a set of ranking images by applying degradation to the high-quality ROI image, extracting a first feature set from the low-quality ROI image and a feature set from each ranking image in the set of ranking images using the deep neural network, and determining a selected ranking image in the set of ranking images having the feature set corresponding to the first feature set.

### BACKGROUND

Image quality assessment has long been a challenging problem in the fields of image processing and computer vision. Traditionally, approaches to this problem have been categorized into full-reference and no-reference methods, with various metrics such as Just Noticeable Difference (JND), Mean Opinion Score (MOS), and image rulers being used to quantify image quality. The ultimate goal of these methods is to predict a quality score that correlates well with human perception.

In recent years, deep learning has led to more complex models, particularly deep convolutional neural networks (CNNs), being applied to the problem of image quality assessment. These approaches have ranged from classification and regression tasks to metric learning. The primary advantage of using CNNs is their ability to replace hand-crafted features with end-to-end feature learning systems, often resulting in state-of-the-art performance.

Despite these advancements, challenges remain in creating systems that can accurately assess image quality across different devices and capture conditions, while aligning closely with human perceptual judgments. There is also a need for methods that can focus on specific regions of interest within images and handle variations in texture and noise characteristics.

### SUMMARY

An embodiment discloses a method of automated image quality (IQ) assessment using a deep neural network. The method comprises detecting a region of interest (ROI) of an image pair to generate a low-quality ROI image and a high-quality ROI image accordingly. The image pair comprises a low-quality image and a high-quality image. The method further comprises generating a set of ranking images by applying degradation to the high-quality ROI image, extracting a first feature set from the low-quality ROI image and a feature set from each ranking image in the set of ranking images using the deep neural network, and determining a selected ranking image in the set of ranking images having the feature set corresponding to the first feature set.

An embodiment discloses a method of training a deep neural network for automated image quality assessment. The method comprises obtaining a plurality of image pairs. Each image pair comprises a low-quality image and a high-quality image. The method further comprises detecting a region of interest (ROI) for each image pair to generate a low-quality ROI image and a high-quality ROI image,

generating a set of ranking images by applying degradation to the high-quality ROI image, obtaining a label indicating which ranking image from the set is most similar to the low-quality ROI image, and training the deep neural network using the low-quality ROI image, the set of ranking images, and the labels.

An embodiment discloses an apparatus comprising one or more processors. The processor is configured to detect a region of interest (ROI) of an image pair comprising a low-quality image and a high-quality image, and generate a low-quality ROI image and a high-quality ROI image accordingly, generate a set of ranking images by applying degradation to the high-quality ROI image, extract a first feature set from the low-quality ROI image and a feature set from each ranking image in the set of ranking images using the deep neural network, and determine a selected ranking image in the set of ranking images having the feature set corresponding to the first feature set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts an automated image quality (IQ) assessment system according to the embodiments.

FIG. 2 depicts an exemplary labeling process associated with automated image quality assessment system of FIG. 1.

FIG. 3 is a flowchart illustrating a method of automated IQ assessment according to the embodiments.

FIG. 4 is a flowchart illustrating a method of training a deep neural network for automated IQ assessment according to the embodiments.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

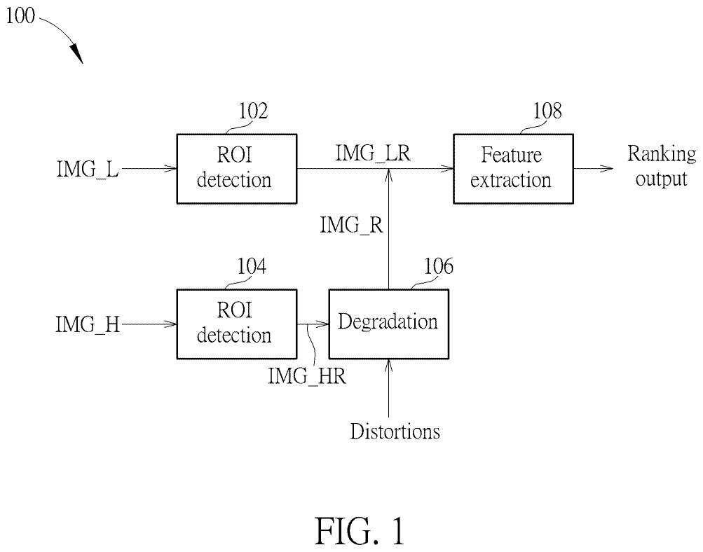

FIG. 1 depicts an automated image quality (IQ) assessment system 100 according to the embodiments. The IQ assessment system 100 includes a region of interest (ROI) detection blocks 102 and 104, a degradation block 106, and a feature extraction block 108. The ROI detection blocks 102 and 104 are responsible for identifying critical areas in the input images for focused quality assessment. The degradation block 106 applies various distortions to the high-quality reference image, creating a set of ranking images for comparison. The feature extraction block 108 employs advanced machine learning techniques to extract relevant features from images.

The automated IQ assessment process begins by inputting a low-quality image IMG_L into ROI detection block 102 and a high-quality image IMG_H into ROI detection block 104 to generate a low-quality image IMG_LR and a high-quality image IMG_HR respectively. The low-quality ROI image IMG_LR and the high-quality ROI image IMG_HR represent the ROI region of the respective low-quality image IMG_L and high-quality image IMG_H. The high-quality ROI image IMG_HR is then subjected to a degradation process by the degradation block 106. The degradation process applies two types of distortions: blur and noise functions. This process generates a set of ranking images IMG_R with varying levels of degradation.

The ROI detection blocks 102 and 104 can detect a region of interest, for example, based on a predefined location. In certain embodiments, the ROI detection blocks 102 and 104 may incorporate deep neural networks, segmentation algorithms and/or computer vision algorithms.

In certain embodiments of the invention, the system is designed to accommodate and compare images from various sources and capture conditions. Specifically, the low-quality image IMG_L and the high-quality image IMG_H can originate from different capture scenarios. The low-quality image IMG_L may be obtained using a first sensor device, which could be a lower-resolution camera or a sensor with different capabilities. Alternatively, it could be captured using the same device but at a wider field of view, which often results in lower detail for specific regions of interest.

Conversely, the high-quality image IMG_H can be acquired through different means. It might be captured using a second sensor device, potentially one with superior imaging capabilities, such as a higher resolution, better low-light performance, or advanced optical systems. This second device could be a different camera altogether or a secondary camera on the same mobile device. Another possibility is that the high-quality image IMG_H is captured using the same device as the low-quality image IMG_L, but with a narrower field of view, for instance, using a zoom lens or a higher zoom setting. This approach allows for capturing more detail in the region of interest, resulting in a higher quality image for that specific area.

The low-quality ROI image IMG_LR, along with the set of ranking images IMG_R, are then fed into a feature extraction block 108. The feature extraction block 108, implemented as a deep neural network, extracts relevant features from both the low-quality ROI image IMG_LR and each of the ranking images IMG_R.

Then, the feature extraction block 108 also determines an IQ score for the low-quality image IMG_L by comparing the feature set of the low-quality image IMG_L and the corresponding feature set of each of the ranking images IMG_R.

It should be noted that the above-mentioned features are the output of the feature extraction process applied by the feature extraction block 108 to both the low-quality ROI image IMG_LR and the set of ranking images IMG_R. The feature extraction process transforms the images into a set of numerical features that represent their key characteristics. Then, the feature extraction block 108 calculates a corresponding value(for example, the distance, a measure of dissimilarity or any other kind of corresponding value) between the feature set of the low-quality ROI image IMG_LR and the feature set of each of ranking images IMG_R. The distance calculation is typically done using a mathematical distance metric such as Euclidean distance or cosine similarity. In some embodiments, when the minimum distance is found, it indicates which ranking image corresponds to (for example, is most similar to) the low-quality ROI image IMG_LR. This minimum distance indicates the highest similarity between the low-quality ROI image IMG_LR and that particular ranking image. The index of this most similar ranking image represents the final ranking output or IQ score. For example, if the most similar ranking image is the third image in the set, the low-quality image would receive an IQ score of 3.

In certain embodiments, the set of ranking images can be arranged in a 11×11 grid, with noise levels increasing from left to right (0 to 10) and texture quality increasing from top to bottom (0 to 10). In this case, if the most similar ranking image has noise level of 10 and texture quality of 2, the low-quality image would receive an IQ score with N=10 and T=2.

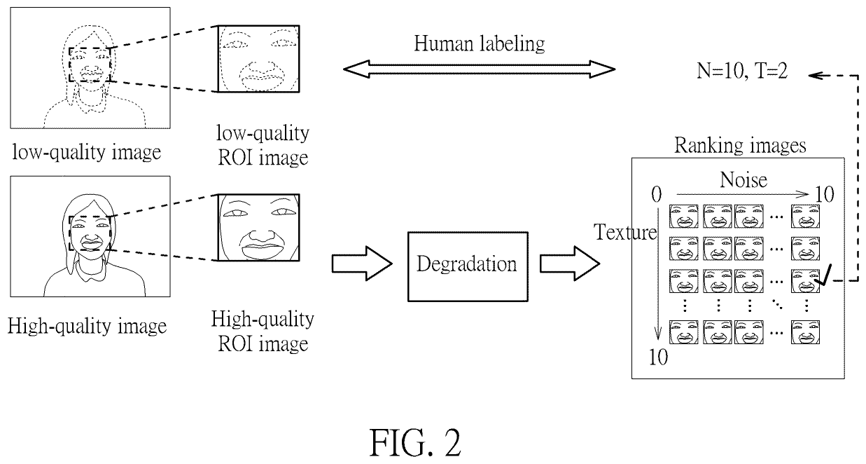

FIG. 2 depicts an exemplary labeling process (for example, a labeling process for human-related feature) associated with automated image quality assessment system 100 of FIG. 1. In this embodiment, a low-quality image is illustrated, which is a full portrait of a person smiling; a high-quality image is also illustrated, which is similar portrait of the same person, but clear (e.g., higher resolution). The low-quality ROI image and the high-quality ROI images are close-ups of the face area from the respective low-quality and high-quality images. Furthermore, the degradation process is applied to the high quality ROI image to generate a set of ranking images arranged in a grid. The set of ranking images can be indexed, for example, from 0 to 10, representing varying level of noise and texture. In this example, the vertical axis represents texture score and the horizontal axis represents noise score. The set of ranking images are arranged in a 11×11 grid, with noise levels increasing from left to right (0 to 10) and texture quality increasing from top to bottom (0 to 10).

The texture scores can be associated with resolution, dynamic range, Gaussian blur, motion blur, bilateral blur, box blur and/or radial blur. Similarly, the noise scores can be associated with Gaussian noise, Poisson noise, shot noise and/or impulsive noise, low-frequency noise.

The labeling process, as illustrated in the FIG. 2, serves as a crucial component in the image quality assessment system. This process facilitates the identification of a ranking image from a predetermined set that exhibits the highest degree of similarity to the low-quality Region of Interest (ROI) image.

In the exemplary embodiment depicted, the evaluator has determined that the ranking image characterized by a noise score (N) of 10 and a texture score (T) of 2 demonstrates the closest correspondence to the low-quality ROI image. This label is visually represented in the figure by the notation “N=10, T=2”.

The aforementioned labeling procedure provides a quantitative measure of the subjective image quality perception and training for the deep neural network used by the feature extraction block 108. In some embodiments, the aforementioned labeling procedure can be used to label human-related feature or any other kind of feature. By associating the low-quality ROI with a specific ranking image, the system effectively translates visual assessment (for example, the visual assessment related to human feature or any other kind of feature) into numerical parameters. These parameters, in turn, can be utilized for the calibration, training, and validation of the automated image quality assessment algorithms.

In certain embodiments, it incorporates a dynamic learning mechanism that enables the deep neural network in the feature extraction block 108 to continuously evolve and improve during its operational use. This ongoing training process integrates human expertise with machine learning capabilities. It involves a two-step approach: first, a human evaluator compares a low-quality ROI image to a set of ranking images, selecting the one that most closely matches in perceived quality. Then, the neural network is fine-tuned using this human-provided label along with the original low-quality ROI image and the complete set of ranking images. This process allows the system to consistently align its automated assessments with human perceptual judgments, adapting to changes in quality standards and image degradation patterns over time. By combining the efficiency of machine learning with the nuanced perception of human experts, the automated IQ assessment system 100 maintains its relevance and accuracy, potentially improving its performance as it processes more images and incorporates more human feedback.

This adaptive learning approach offers several advantages. It enables the automated IQ assessment system 100 to remain current and effective in the face of evolving image quality standards or changes in the types of degradations encountered. Additionally, it allows the automated IQ assessment system 100 to benefit from the ongoing input of humans, potentially leading to more nuanced and accurate assessments over time. This combination of machine learning efficiency and perceptual expertise (for example, human perceptual expertise) creates a robust and flexible system capable of handling a wide range of image quality assessment scenarios.

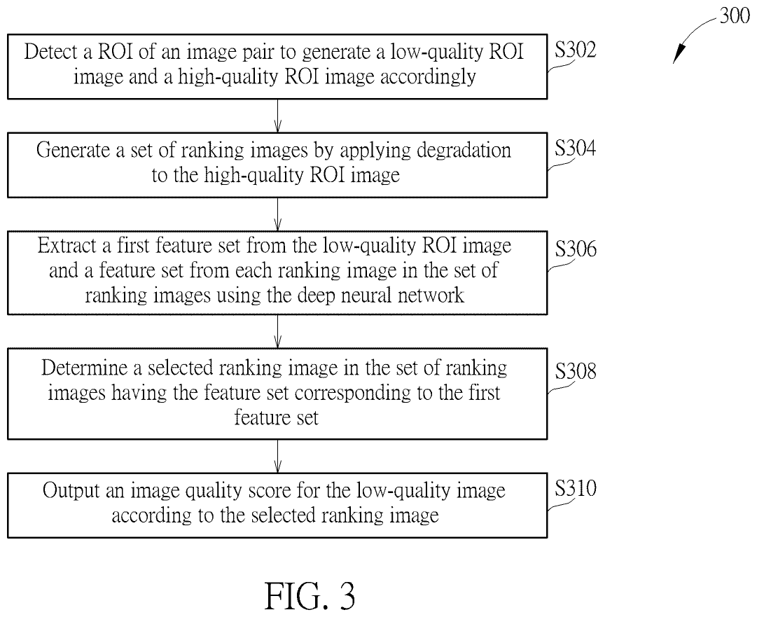

To summarize the above-mentioned automated IQ assessment process, a method 300 of automated IQ assessment is depicted in FIG. 3, which includes the following steps:

S302: Detect an ROI of an image pair to generate a low-quality ROI image and a high-quality ROI image accordingly;

S304: Generate a set of ranking images by applying degradation to the high-quality ROI image;

S306: Extract a first feature set from the low-quality ROI image and a feature set from each ranking image in the set of ranking images using the deep neural network;

S308: Determine a selected ranking image in the set of ranking images having the feature set corresponding to the first feature set; and

S310: Output an image quality score for the low-quality image according to the selected ranking image.

As mentioned above, the image pair comprises a low-quality image and a high-quality image.

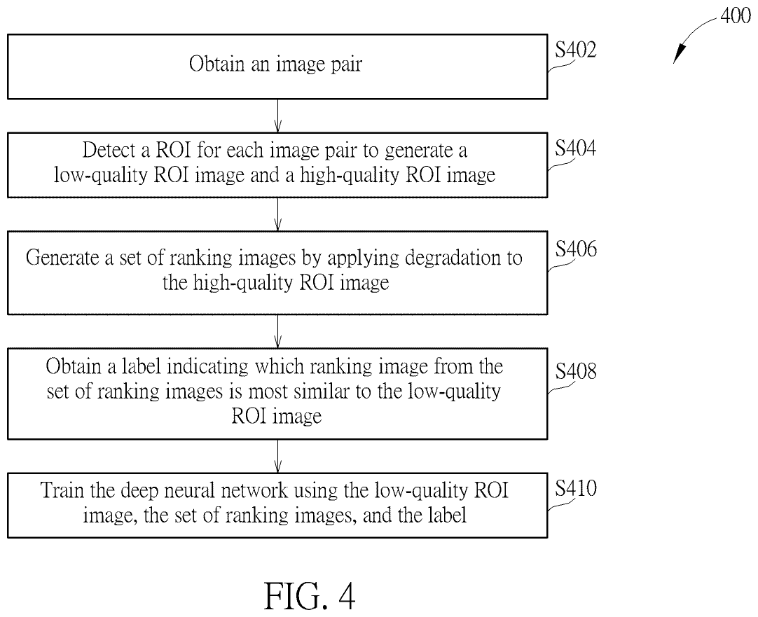

In addition to the aforementioned application, a method 400 of training a deep neural network for the above-described automated IQ assessment, as depicted in FIG. 4, includes the following steps:

S402: obtain an image pair;

S404: Detect an ROI for each image pair to generate a low-quality ROI image and a high-quality ROI image;

S406: Generate a set of ranking images by applying degradation to the high-quality ROI image;

S408: Obtain a label indicating which ranking image from the set of ranking images is most similar to the low-quality ROI image; and

S410: Train the deep neural network using the low-quality ROI image, the set of ranking images, and the label.

It should be noted that the image pair comprises a low-quality image and a high-quality image. Also in step S410, training the deep neural network can include extracting a feature set from the low-quality ROI image and a feature set from each ranking image, and minimizing a distance between the feature set of the low-quality ROI image and a corresponding feature set of each ranking image, for example, by implementing a loss function.

Please note that the training is an iterative optimization process, in which parameters of the deep neural network are adjusted to align its assessments with human perceptual judgments (i.e., human labeling).

The trained deep neural network learns to extract features that correspond to human perception of image quality, enabling the network to assess texture or noise characteristics in subsequent applications, and the method enables simultaneous evaluation of image data from different mobile devices.

The embodiments presented in this disclosure offer several key advantages. It introduces a generalized framework for self-supervised learning from rankings that can be applied to multiple regression problems, demonstrating its versatility in both image quality assessment and crowd counting. By providing methods to automatically generate rankings from unlabeled data and incorporating an active learning strategy, the framework substantially reduces the need for manual labeling. The flexible architecture allows for adaptation to various problems and network structures, and the use of image rulers enhances interpretability. Importantly, it offers state-of-the-art performance on both IQA and crowd counting tasks, with improved generalization even to unseen distortions. These combined innovations represent a significant advancement in leveraging unlabeled data and self-supervised learning for regression problems in computer vision, offering a more efficient, adaptable, and powerful approach than previous methods.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automated image quality (IQ) assessment using a deep neural network, comprising:
detecting a region of interest (ROI) of an image pair to generate a low-quality ROI image and a high-quality ROI image accordingly, wherein the image pair comprises a low-quality image and a high-quality image;
generating a set of ranking images by applying degradation to the high-quality ROI image;
extracting a first feature set from the low-quality ROI image and a feature set from each ranking image in the set of ranking images using the deep neural network; and
determining a selected ranking image in the set of ranking images having the feature set corresponding to the first feature set.

2. The method of claim 1, further comprising outputting an image quality score for the low-quality image according to the selected ranking image.

3. The method of claim 2, wherein the set of ranking images are arranged by a set of indexes and the set of indexes represent texture scores and noise scores.

4. The method of claim 2, wherein the texture scores are associated with resolution, dynamic range, Gaussian blur, motion blur, bilateral blur, box blur and/or radial blur.

5. The method of claim 2, wherein the noise scores are associated with Gaussian noise, Poisson noise, shot noise and/or impulsive noise, low-frequency noise.

6. The method of claim 1, wherein the low-quality image is captured by a first sensor device or at a first field of view, and the high-quality image is captured by a second sensor device or at a second field of view.

7. The method of claim 1, wherein detecting the ROI of the image pair is based on a detection algorithm comprising another deep neural network, a segmentation algorithm and/or a computer vision algorithm.

8. The method of claim 1, further comprising:
obtaining a human label indicating which ranking image from the set of ranking images is most similar to the low-quality ROI image; and
training the deep neural network using the low-quality ROI image, the set of ranking images, and the human label.

9. A method of training a deep neural network for automated image quality assessment, comprising:
obtaining an image pair comprising a low-quality image and a high-quality image;
detecting a region of interest (ROI) for the image pair to generate a low-quality ROI image and a high-quality ROI image;
generating a set of ranking images by applying degradation to the high-quality ROI image;
obtaining a label indicating which ranking image from the set of ranking images corresponding to the low-quality ROI image; and
training the deep neural network using the low-quality ROI image, the set of ranking images, and the label.

10. The method of claim 9, wherein the low-quality image is captured by a first sensor device or at a first field of view, and the high-quality image captured by a second sensor device or at a second field of view.

11. The method of claim 9, wherein training the deep neural network using the low-quality ROI image, the set of ranking images, and the labels comprises:
extracting a first feature set from the low-quality ROI image and a feature set from each of the set of ranking images; and
minimizing a distance between the first feature set and a corresponding feature set of each ranking image.

12. The method of claim 9, wherein detecting the ROI of each image pair is based on a detection algorithm comprising another deep neural network, a segmentation algorithm and/or a computer vision algorithm.

13. An apparatus comprising one or more processors, configured to:
detect a region of interest (ROI) of an image pair comprising a low-quality image and a high-quality image, and generate a low-quality ROI image and a high-quality ROI image accordingly;
generate a set of ranking images by applying degradation to the high-quality ROI image;
extract a first feature set from the low-quality ROI image and a feature set from each ranking image in the set of ranking images using the deep neural network; and
determine a selected ranking image in the set of ranking images having the feature set corresponding to the first feature set.

14. The apparatus of claim 13, wherein the processor is further configured to output an image quality score for the low-quality image according to the set of ranking images.

15. The apparatus of claim 14, wherein the set of ranking images are arranged by a set of indexes and the set of indexes represent texture scores and noise scores.

16. The apparatus of claim 14, wherein the texture scores are associated with resolution, dynamic range, Gaussian blur, motion blur, bilateral blur, box blur and/or radial blur.

17. The apparatus of claim 14, wherein the noise scores are associated with Gaussian noise, Poisson noise, shot noise and/or impulsive noise, low-frequency noise.

18. The apparatus of claim 13, wherein the low-quality image is captured by a first sensor device or at a first field of view, and the high-quality image is captured by a second sensor device or at a second field of view.

19. The apparatus of claim 13, wherein detecting the ROI of the image pair is based on a detection algorithm comprising another deep neural network, a segmentation algorithm and/or a computer vision algorithm.

20. The apparatus of claim 13, further comprising a sensor device configured to capture the low quality image and/or the high quality image.
